(19) United States
(12) Patent Application Publication
(10) Pub. No.: US 2012/0301580 A1
(43) Pub. Date: Nov. 29, 2012

(54) MICROBIAL CONTROL METHOD AND FOOD COMPOSITION

(75) Inventor: Carl J. Knueven, Bowling Green, OH (US)

(73) Assignee: JONES-HAMILTON CO., Walbridge, OH (US)

(21) Appl. No.: 13/478,262

(22) Filed: May 23, 2012

Related U.S. Application Data
(60) Provisional application No. 61/489,744, filed on May 25, 2011.

(51) Int. Cl. A23L 3/358; A23K 1/00

(52) U.S. Cl. 426/96; 426/289

(57) ABSTRACT

A microbial control method includes applying dry particles of alkali metal bisulfate to an outer surface of a dry food to control microbial contamination of the food. A food composition includes a dry food having an outer surface covered with dry particles of alkali metal bisulfate that control microbial contamination of the food.

### CROSS-REFERENCE TO RELATED APPLICATIONS

This application claims the benefit of U.S. Provisional Application No. 61/489,744, filed May 25, 2011, the disclosure of which is incorporated herein by reference.

### BACKGROUND OF THE INVENTION

This invention relates in general to antimicrobial technologies, and in particular to methods and compositions for controlling the microbial contamination of dry foods.

Controlling the microbial contamination of foods for humans and animals is vitally important for reasons of safety and food preservation. Contamination of pet foods can cause illness of not only the pets but also their human owners, because the pet food is handled by humans and is present inside the home. In 2011, the U.S. Food and Drug Administration alerted the pet food industry that the agency will determine the prevalence of Salmonella in pet foods and ensure that contaminated foods are removed from interstate commerce.

Microbial control strategies in pet food manufacturing plants can be divided into three broad categories: 1) Prevent contamination from entering the facility. This can be done by controlling dust, managing the flow of equipment and humans, controlling pests, and sanitation of transport vehicles. 2) Reduce microbial growth within the plant. This can be done by discovering growth niches and reducing conditions that lead to growth. 3) Procedures designed to kill the microbes. Examples of these procedures include thermal processing, alternative technologies, and antimicrobial interventions.

Among the antimicrobial interventions, oxidizing agents such as chlorine, hydrogen peroxide and peroxyacetic acid have been used in wash solutions. Organic acids such as citric acid have traditionally been used in human and animal foods to control microbes by lowering pH. The organic acids may require long contact times to reduce contamination, and they may be more effective on low levels of contamination. Also, the sour taste of the organic acids may cause palability issues.

There is still a need for an improved microbial control method, particularly a method that can be used to control microbes on dry foods.

### SUMMARY OF THE INVENTION

This invention relates to a microbial control method which comprises applying dry particles of alkali metal bisulfate to an outer surface of a dry food to control microbial contamination of the food.

The invention also relates to a food composition comprising a dry food having an outer surface covered with dry particles of alkali metal bisulfate that control microbial contamination of the food.

Various aspects of this invention will become apparent to those skilled in the art from the following detailed description of the preferred embodiment, when read in light of the accompanying drawings.

### DETAILED DESCRIPTION OF THE PREFERRED EMBODIMENT

The present invention relates to a method and composition for controlling microbes on dry foods. Microbial control on dry foods is a particular problem because microbes in their dry dormant state are not killed by the antimicrobial methods typically used in food manufacturing plants. The microbes can survive and remain dormant on the foods for long periods of time under dry conditions. Accidental introduction of water to the foods in the process environment can cause revival and growth of the microbes and severe contamination problems.

In the microbial control method of the present invention, dry particles of alkali metal bisulfate are applied to an outer surface of a dry food to control microbial contamination of the food. While not intending to be limited by theory, it is believed that the application of the alkali metal bisulfate particles controls microbial contamination by one or both of the following possible mechanisms: 1) The alkali metal bisulfate particles are hygroscopic. They exert an osmotic effect and draw water from the microbes upon contact causing dehydration and death. 2) The water drawn from the microbes causes the alkali metal bisulfate particles to solubilize, producing a low pH environment in direct contact with the microbes that kills them.

The alkali metal bisulfates include, for example, sodium bisulfate (i.e., sodium acid sulfate or sodium hydrogen sulfate), potassium bisulfate (i.e., potassium acid sulfate or potassium hydrogen sulfate), or mixtures thereof. Sodium bisulfate is usually in dry particle form. In the presence of water, sodium bisulfate dissociates into sodium ions, hydrogen ions (which lower the pH), and sulfate ions.

An example of a sodium bisulfate product that can be used in the present microbial control method is manufactured and sold under the brand name SBS Pet® by Jones-Hamilton Co., Walbridge, Ohio 43465. The following Jones-Hamilton patents disclose earlier animal feed grade and human food grade sodium bisulfate products: U.S. Pat. Nos. 5,707,658; 5,773,063; 5,958,491; 6,132,792; 6,620,445; 7,048,803; and 7,097,861 which are incorporated by reference herein.

A preferred alkali metal bisulfate for use in the microbial control method has a relatively small particle size. In certain embodiments, at least about 95 wt % or at least about 99 wt % of the alkali metal bisulfate particles are not larger than about 60 mesh by U.S. Standard Sieve Size (not larger than about 0.25 mm). Also, in certain embodiments, at least about 80 wt % or at least about 90 wt % of the particles are not larger than about 100 mesh (not larger than about 0.149 mm). A particular example of an SBS Pet® sodium bisulfate product is in the form of a powder having a particle size of 0.25 wt % 40 mesh (0.42 mm), 7.60 wt % 60 mesh (0.25 mm), 22.48 wt % 100 mesh (0.149 mm), and 69.68 wt % pan. This product may be produced, for example, by milling and/or grinding an animal feed grade sodium bisulfate product into a small particle size powder.

Sodium bisulfate has some unique characteristics that make it particularly suitable for use in the microbial control method. It is a strong acidifier (a 1% solution has a pH of 1). It can be applied to the food as a dry powder therefore it is not neutralized upon application to the food. It is very soluble in water, 50% @ 60° F. (15.6° C.). It is less sour than organic acids. It is nonhazardous and safe to handle.

Any suitable application method and equipment can be used to apply the dry particles of alkali metal bisulfate to the outer surface of the dry food. For example, the particles can be applied by enrobing or spraying them onto the surface to form a coating on the food, or by mixing together the particles and the food until the food becomes coated. Spray equipment may employ compressed air or an electrostatic charge. Other equipment that may be used include a powder booth or a fluidized bed.

In certain embodiments, the particles of alkali metal bisulfate are applied to the dry food in combination with one or more other materials. The alkali metal bisulfate and other material(s) can be applied either together or separately. For example, one material that can be applied is a palatability enhancer such as a flavor enhancer, to improve the palatability of the dry food product. Another material that can be applied is powdered salt or sweetener, or a stabilizer to improve the stability of the product. Another material is a flow aid to improve the flow characteristics of the alkali metal bisulfate. A binder could also be applied to improve the adhesion of the alkali metal bisulfate to the food product.

In a particular example, the alkali metal bisulfate particles are applied in a process for the manufacture of dry pet food. The manufacturing plant typically includes a machine that enrobes a coating such as a flavor enhancer onto the surface of the pot food after it has been extruded and dried. The alkali metal bisulfate particles can be applied along with the flavor enhancer using the same enrobing machine, thereby saving the cost of additional equipment and process modification.

A process for the manufacture of dry pet food by extrusion is described in more detail by the Pet Food Institute in an article entitled “How Dry Pet Food Is Made” at www.petfoodinstitute.com: “1. Ingredients are brought together in a mixer. Dry ingredients may be ground prior to introduction to wet ingredients. Once mixed together, they form a moist dough. 2. The dough is heated in the preconditioner prior to introduction to the extruder. 3. The extruder . . . is where the primary cooking phase for dry extruded pet food products occurs. The dough is cooked under intense heat and pressure as it moves toward the open end of the extruder. At the end of the extruder, hot dough passes through a shaping die and knife . . . where the small pieces expand rapidly into kibble once they are under standard air pressure. 4. Kibble is dried in an oven until its moisture content is low enough to make it shelf stable like a cookie or cracker. The drying oven is followed by a cooling phase. 5. After cooling, kibble may pass through a machine that enrobes a coating, which is generally a flavor enhancer. 6. Packaging (bags, boxes, pouches, etc.) is filled during the last step . . . . The final result is finished pet foods or treats.” The particles of alkali metal bisulfate may be applied in step 5 along with the flavor enhancer.

In certain embodiments, the alkali metal bisulfate particles are applied to control microbial recontamination of a food product that was earlier contaminated and then decontaminated. For example, as described above, the production of pet food kibble involves a high temperature extrusion step that kills Salmonella and other microbes present in the raw materials. However, the kibble can be recontaminated with microbes present in the processing environment after the extruder. The application of the alkali metal bisulfate after extrusion can control/prevent this recontamination by killing microbes that come into contact with the kibble.

The particles of alkali metal bisulfate are applied to the outer surface of the dry food—in other words, the outer boundary or perimeter, or the exterior face of the food. In certain embodiments, after application the alkali metal bisulfate is present only on the outer surface and it is not present in the interior of the food.

The particles are applied with adequate coverage of the food surface to be effective for the desired microbial control. In certain embodiments, the applied particles cover substantially all regions of the surface although there may be some space and exposed surface between the particles. In other embodiments, the applied particles cover substantially all regions and substantially no surface of the food is left exposed. Also, in certain embodiments, the applied particles form a continuous coating on the surface of the food. For example, the coating may have a thickness of from about 0.1 mm to about 1.0 mm.

The particles of alkali metal bisulfate can be applied to the dry food in any suitable amount. In certain embodiments, the alkali metal bisulfate is applied in an amount from about 0.1% to about 5% by weight of the dry food, and more particularly from about 0.1% to about 2%.

The term “dry food” as used herein means a food having a water activity of not higher than about 0.90. In certain embodiments, the water activity is not higher than about 0.70, and more particularly not higher than about 0.60. The water activity determines the lower limit of available water for microbial growth, and it differs somewhat depending on the type of microbe. Water activity is defined as the vapor pressure of water over a sample divided by the vapor pressure of pure water at a given temperature. Different methods of measuring water activity are well known, such as a chilled mirror dewpoint method, or a method that uses resistance or capacitance sensors to measure relative humidity.

In certain embodiments, the dry food has a moisture content of not greater than about 15%. In some more particular embodiments, the moisture content is not greater than about 13% or not greater than about 11%. Methods of measuring moisture content in foods are well known.

The dry food can be intended for consumption by a human or by an animal. Some nonlimiting examples of dry pet foods include kibble, bits, treats, and biscuits for dogs or cats. A variety of different animal feeds are known. Some nonlimiting examples of dry human foods include cereals; dry snacks; dried meat, poultry, fish and seafood products; dried vegetables; nuts and associated butters; dry bakery products and ingredients; and powdered milk and eggs. Compositions and methods of making dry foods are well known.

The microbial control method can be used for controlling any types of microbes. The term “microbe” is synonymous with “microorganism,” and refers to any noncellular or unicellular (including colonial) organism, including all prokaryotes. Microbes include bacteria (including cyanobacteria), lichens, fungi, protozoa, virinos, viroids, viruses, phages, and some algae. In certain embodiments, the microbes are bacteria such as Salmonella, Escherichia coli, Campylobacter, Listeria, Pseudomonas, Acinetobacter, Moraxella, Alcaligenes, Flavobacterium, Erwinia, yeast, mold, or the like.

The microbial control method can have any suitable degree of effectiveness for controlling microbes. In certain embodiments, the method is effective to reduce Salmonella to non-detectable by one day after exposure of the dry food to this microbe.

The principle and mode of operation of this invention have been explained and illustrated in its preferred embodiment. However, it must be understood that this invention may be practiced otherwise than as specifically explained and illustrated without departing from its spirit or scope.

### EXAMPLES

### Salmonella Dog Kibble Test

### Applied SBS-Pet® to Outside of Kibble

2 application methods
SBS Powder application—final step
SBS Powder mixed with flavor component
Salmonella reduced to non-detectable by day 1

### Flavor and SBS Powder Application

### Dog Kibble Salmonella Test

Inoculated with 4 strains of salmonella—
S enterica ATCC #13076, S anatum ATCC #9270
   S choleraesuis ATCC #13311, S senftenberg ATCC #8400
      Overnight cultures diluted with sterile diluent to arrive at inoculation level of 600,000 cfu/mL. 1000 grams of test diet was inoculated with 12 mL of Salmonella to give a theoretical level of 7200 cfu/g.
      Measured quantitative levels with Standard methods agar (nonselective) and XLD agar (selective)
      Time 0, day 1, 2, 3, 5, etc. were tested.

SBS Powder - Salmonella

| | Salmonella | Salmonella | Salmonella | Salmonella |
|---|---|---|---|---|
| | count | count | count | count |
| Diet | Day 0 | Day 1 | Day 2 | Day 3 |
| Control | 9000 | 650 | 230 | 220 |
| Diet 1 | 580 | n.d. | n.d. | n.d. |
| Diet 2 | n.d. | n.d. | n.d. | n.d. |
| Diet 3 | n.d. | n.d. | n.d. | n.d. |
| Diet 4 | 30 | n.d. | n.d. | n.d. |
| Diet 5 | 350 | 20 | n.d. | n.d. |

Control - 7% fat, 1% flavor
Diet 1 - 7% fat, 1% flavor, 0.25% SBS Pet
Diet 2 - 7% fat, 1% flavor, 0.5% SBS Pet
Diet 3 - 7% fat, 1% flavor, 1.0% SBS Pet
Diet 4 - 7% fat, 1% flavor, 025% SBS Pet, 0.25% lactic acid
Diet 5 - 7% fat, 1% flavor, 0.5% lactic acid
n.d.—Not Detected
Method - FDA III, Detection limit 10

SBS Powder - Aerobic Plate

| | Aerobic | Aerobic | Aerobic | Aerobic |
|---|---|---|---|---|
| | Count | Count | Count | Count |
| Diet | Day 0 | Day 1 | Day 2 | Day 3 |
| Control | 25000 | 1600 | 1300 | 1300 |
| Diet 1 | 3000 | n.d. | 30 | n.d. |
| Diet 2 | 10 | 10 | 10 | n.d. |
| Diet 3 | n.d. | n.d. | n.d. | n.d. |
| Diet 4 | 500 | n.d. | 40 | n.d. |
| Diet 5 | 4200 | 40 | 90 | n.d. |

Control - 7% fat, 1% flavor
Diet 1 - 7% fat, 1% flavor, 0.25% SBS Pet
Diet 2 - 7% fat, 1% flavor, 0.5% SBS Pet
Diet 3 - 7% fat, 1% flavor, 1.0% SBS Pet
Diet 4 - 7% fat, 1% flavor, 025% SBS Pet, 0.25% lactic acid
Diet 5 - 7% fat, 1% flavor, 0.5% lactic acid
n.d.—Not Detected
Method - FDA III, Detection limit 10

SBS Powder Mixed with Flavor Salmonella

| | Salmonella | Salmonella | Salmonella |
|---|---|---|---|
| | count | count | count |
| Diet | Day 0 | Day 1 | Day 2 |
| Control 1 | 9000 | 650 | 230 |
| Control 2 | 4500 | 2800 | 600 |
| Diet 9 | n.d. | n.d. | n.d. |
| Diet 10 | n.d. | n.d. | n.d. |
| Diet 11 | n.d. | n.d. | n.d. |

Diet 9 - Five pounds of kibble, 7% fat, 1% flavor mixed with 0.25% SBS.
Diet 10 - Five pounds of kibble, 7% fat, 1% flavor mixed with 0.50% SBS.
Diet 11 - Five pounds of kibble, 7% fat, 1% flavor mixed with 0.75% SBS.
Control data from previous tests

SBS Powder Mixed with Flavor Aerobic Plate Count

| | Aerobic | Aerobic | Aerobic |
|---|---|---|---|
| | Count | Count | Count |
| Diet | Day 0 | Day 1 | Day 2 |
| Control 1 | 25000 | 1600 | 1300 |
| Control 2 | 16000 | 26000 | 4400 |
| Diet 9 | 180 | 60 | 30 |
| Diet 10 | 590 | 30 | 10 |
| Diet 11 | 1020 | n.d. | 20 |

Diet 9 - Five pounds of kibble, 7% fat, 1% flavor mixed with 0.25% SBS.
Diet 10 - Five pounds of kibble, 7% fat, 1% flavor mixed with 0.50% SBS.
Diet 11 - Five pounds of kibble, 7% fat, 1% flavor mixed with 0.75% SBS.
Control data from previous tests

What is claimed is:

1. A microbial control method which comprises applying dry particles of alkali metal bisulfate to an outer surface of a dry food to control microbial contamination of the food.

2. The method of claim 1 wherein the particles have a size not larger than about 60 mesh.

3. The method of claim 1 wherein the applied particles form a continuous coating on the surface.

4. The method of claim 1 wherein the alkali metal bisulfate is sodium bisulfate.

5. The method of claim 1 wherein the food is pet food.

6. The method of claim 5 wherein the pet food is kibble.

7. The method of claim 1 wherein the particles are applied to control recontamination of the food.

8. The method of claim 1 wherein the particles are applied in combination with a palatability enhancer.

9. The method of claim 1 wherein the particles are applied in combination with a flow aid.

10. The method of claim 1 wherein the method is effective to kill dormant microbes.

11. The method of claim 1 wherein the method causes both an osmotic effect and a low pH effect on the microbes.

12. The method of claim 1 wherein the alkali metal bisulfate is applied in an amount from about 0.1% to about 5% by weight of the food.

13. A food composition comprising a dry food having an outer surface covered with dry particles of alkali metal bisulfate that control microbial contamination of the food.

14. The food composition of claim 13 wherein the particles have a size not larger than about 60 mesh.

15. The food composition of claim 13 wherein the particles form a continuous coating on the surface.

16. The food composition of claim 13 wherein the alkali metal bisulfate is sodium bisulfate.

17. The food composition of claim 13 wherein the food is pet food.

18. The food composition of claim 17 wherein the pet food is kibble.

19. The food composition of claim 13 wherein the particles are mixed with a palatability enhancer.

20. The food composition of claim 13 wherein the alkali metal bisulfate is included in an amount from about 0.1% to about 5% by weight of the food.
